(19) United States
(12) Patent Application Publication
(10) Pub. No.: US 2003/0103804 A1
(43) Pub. Date: Jun. 5, 2003

(54) Arrangement for an attachment

(76) Inventor: Niklas Bjuhr, Vindeln (SE)

Correspondence Address: Rolf Fasth, Fasth Law Office, 189 Curtis Drive, Longview, WA, 98632-5374, US

(21) Appl. No.: 10/275,192

(22) PCT Filed: May 4, 2001
(86) PCT No.: PCT/SE01/00978

(51) Int. Cl. F16D 1/00

(52) U.S. Cl. 403/321

(57) ABSTRACT

The invention relates to an arrangement for coupling an implement attachment (30) to a working arm (10) of a working machine, wherein the arm (10) is connected to the implement attachment (30) through the medium of fastener sleeves (11, 14) and fastener pins (16, 17). The attachment (30) includes two side-plates (32, 33) which each carry two bushes (44-47) that include holes (56) for accommodating the fastener pins (16, 17). The bushes (44-47) have a circular guide portion (52) which fits into a circular hole (34-37) in respective side-plates (32, 33). The bushes (44-47) include a respective flange (50) which is connected to the side-plates (32, 33) by means of a fastener element (70). The hole (56) receiving respective fastener pins (16, 17) is positioned excentrically in relation to the guide portion (52) in respect of at least two of the bushes (45-47). The invention enables the implement attachment to be adapted readily to mutually different working arms.

The present invention relates to an arrangement pertaining to an implement attachment as defined in the preamble of claim 1. The present invention also relates to a method.

Various types of machine tools, such as excavators, for example, include an arm to which different implements/tools can be connected. The arm thus includes means for connection with the implement attachment. A typical fastener system used in respect of the working arm/shaft/dipper stick of an excavator, digger or corresponding machine resides in the provision of two mutually parallel fastener pins at the tip of said arm, these pins engaging the implement attachment. However, different makes of such machines have different measurements and distances with respect to said fastener pins, therewith requiring the implement attachment to be especially designed for different machine sizes and machine makes. Among other things, this presents a problem with respect to the stocking and the delivery of both the implement attachments and the implements, tools, or mounting systems carried thereby.

The above-mentioned problems are described in U.S. Pat. No. 5,927,665. This US patent specification proposes the use of adapter plugs or bushes of relatively complicated outer contours, said bushes being held in place by means of screws that pass transversely through the bushes and fastener pins. The fastener pins must therefore be designed especially. The adapter plugs are expensive to produce because of a complex construct-ion, and the side-plate cut-outs or recesses required for the adapter plugs are also complicated and expensive. It is also difficult to achieve a close fit.

An object of the present invention is to provide an extremely simple and attractive arrangement with which the aforesaid problems can be solved. This object is achieved with an inventive arrangement and inventive method having the characteristic features set forth in the accompanying claims.

Of the many advantages afforded by the present invention it can be mentioned that the design of the bushes is highly beneficial from a total working aspect. Prevention of rotation of the bushes and fixation of said bushes relative to the side plates is achieved with simple means. Another advantage afforded by the inventive arrangement is that the fastener pins provided by the machine manufacturers can usually be used without requiring modification. The invention also affords both technical and economical advantages.

The invention will now be described by way of example and also with reference to the accompanying drawings, in which

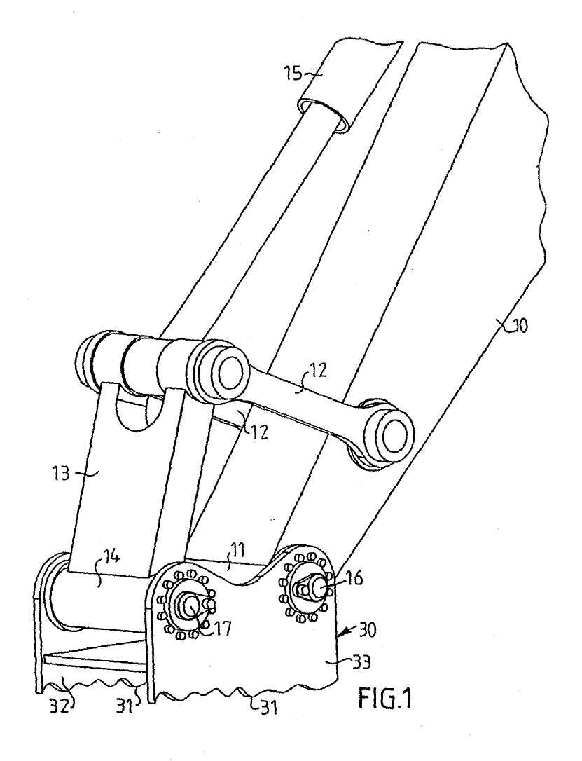

FIG. 1 is a perspective illustration of a working arm in the form of a digger shaft that carries an inventive implement/tool attachment;

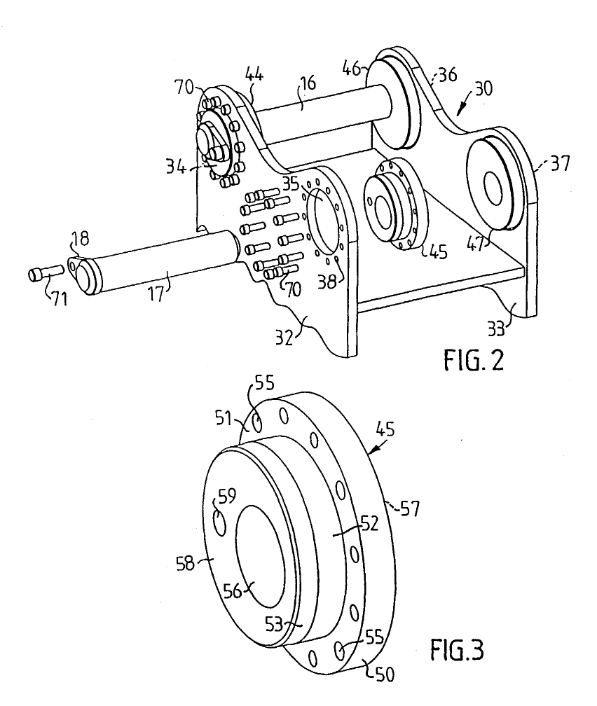

FIG. 2 is a partially exploded perspective view, showing the implement attachment loosened from the shaft; and

FIG. 3 is an enlarged perspective view of a bushing.

FIG. 1 illustrates a typical working arm 10 of an excavator, digger or corresponding machine. The arm 10, which is also known as the machine shaft or dipper stick, carries an inventive implement attachment 30. The arm 10 is shown to carry a fastener sleeve 11 at its lower end. The arm 10 carries a pair of linkage arms 12 which, in turn, carry a lower linkage arm 13. A fastener sleeve 14 is carried at the free end of the linkage arm 13. The working movement of the linkage arms 12 and 13 is effected by a manoeuvring device in the form of an hydraulic cylinder 15. The implement attachment 30 is coupled to the arm 10 by means of two fastener pins 16,17 that extend through the sleeves 11 and 14. Different makes of machine have different positioning of the fastener sleeves 11,14 and their associated fastener pins 16,17, and also vary with respect to sleeve and pin measurements.

The inventive implement attachment 30 is designed so that it can be readily adapted to the measurements and geometric variations of the sleeves 11,14 and the pins 16,17.

The implement attachment 30 can, of course, carry all conceivable types of implement/tools, such as rotators, buckets, shovels, hydraulic hammers, gripping claws, etc. The implement attachment 30 may also carry a quick-fastener or some similar mounting system designed for the implement concerned. Although no implement is shown in the figures, it will be understood that the bottom part 31 of the attachment 30 can be adapted to the implement in question.

The attachment 30 includes two side-plates 32,33 which support an implement/tool (not shown), either directly or indirectly. The side-plate 32 includes two circular holes 34,35, and the side-plate 33 includes two circular holes 36,37. The diameters of the holes 34-37 are much larger than the diameters of respective pins 16,17, so as to enable inventive bushes 44-47 to be mounted in said holes.

The bushes 44-47 include a circular flange 50 that has an inner surface 51 which lies against the inside of the side-plates 32,33, and a circular guide portion 52 which fits snugly in the circular holes 34-37, i.e. in the absence of play. In order to facilitate fitting of the bushes 44-47 in respective holes 34-37, the circular guide portion 52 is provided with an entry portion 53 of slightly smaller diameter than its remaining part. The flanges 50 include a plurality of screw-threaded blind holes 55, and the side-plates 32,33 include corresponding holes 38, so as to enable the bushes 44-47 to be anchored to the side-plates 32,33 by means of screws 70, as shown in FIGS. 1 and 2. It is possible to substitute one or more of the screws 70 for guide pins, provided that the holes in the side-plates 32,33 and in the flanges 50 are adapted to this end.

In accordance with the invention, the bushes 44-47 are adapted to the fastener sleeves 11,14 and the fastener pins 16,17 concerned, by providing holes 56 for the fastener pins 16,17 through the bushes, these holes most often being positioned eccentrically in relation to the centre line of the circular guide portion 52. The circular guide portion 52 has been given a diameter which can accommodate variations in the fastener-pin hole patterns from the machine manufacturers to be covered. The thickness of the flanges of respective bushes 44-47 is adapted to the lengths of respective fastener sleeves concerned, so that the clearances between the fastener sleeves 11,14 and the outer end plane 57 of respective flanges 50 will be a minimum.

One end of the illustrated fastener pins 16,17 carries a perforated shoulder 18, wherewith the pins can be secured in their position of use by screwing said pins into the outer end surface 58 of the bush in question, said end surface including a screw-threaded hole 59 for receiving a screw fastener 71. It will be readily seen that the bushes 44-47 can be easily adapted to enable the use of other commercially-available fastener pins, without needing to modify said pins.

Thus, the inventive implement attachment enables a common attachment including relevant implement and/or accessory, to be finally adapted to comply with customer requirements in conjunction with delivery, by screwing the bushes concerned firmly to the implement attachment. This provides significant advantages with respect to stock holding and delivery times. It is also possible to subsequently change the implement attachment by simply exchanging the bushes, therewith enabling the attachment to be fitted to excavating machines, digging machines, etc., of other manufactures. The invention thus provides a highly rewarding flexibility.

It will also be noted that the outer cylindrical shape of the guide portion of the respective bushes enables play-free connection with corresponding holes in the side-plates, this facility being highly significant from the life expectancy of the bush. However, the outer contour of the flange may deviate from the illustrate cylindrical contour if so desired, for instance when necessary because of space problems.

It will be understood that the detail design of the side-plates may be varied within the scope of the invention, and also their connection to relevant implements or mounting systems.

The invention is therefore not restricted to the illustrated and described embodiment, since changes and modifications are, of course, possible within the scope of the accompanying claims.

1. An arrangement for coupling an implement attachment (30) to a working arm (10) of a working machine, wherein the arm (10) is connected to the implement attachment (30) through the medium of fastener sleeves (11,14) and fastener pins (16,17), and wherein the implement attachment (30) includes two side-plates (32,33) which each carry two bushes (44-47) that have holes (56) for receiving the fastener pins (16,17), characterised in that the bushes (44-47) include a circular guide portion (52) adapted to fit in a circular hole (34-37) in the side-plates (32,33); in that the bushes (44-47) include a flange (50) which is connected to the side-plates (32,33) by means of a fastener element (70); and in that the hole (56) for the fastener pins (16,17) is positioned excentrically in relation to said guide portion (52) in respect of at least two of said bushes (45-47).

2. An arrangement according to claim 1, characterised in that the fastener element (70) extends through respective side-plates (32,33) and is anchored to the flange (50) of respective bushes (44-47).

3. An arrangement according to claim 1 or 2, characterised in that the thickness of the flanges (50) is adapted so that the flanges will essentially fill-out the distance between the side-plates (32,33) and the end parts of the fastener sleeves (11,14).

4. An arrangement according to any one of claims 1-3, characterised in that the side-plates (32,33) are connected to an implement, tool, or mounting system.

5. A method of coupling an implement attachment (30) to a working arm (10) of a working machine, wherein the arm (10) is connected to the implement attachment (30) through the medium of fastener sleeves (11,14) and fastener pins (16,17), wherein the implement attachment (30) includes two side-plates (32,33) which each carry two bushes (44-47) that include holes (56) for receiving said fastener pins (16,17), characterised by using bushes (44-47) that include a circular guide portion (52) which fits into a circular hole (34-37) in the side-plates (32,33); and by using different placements of the fastener pin hole (56) in respective bushings (44-47), so as to enable the attachment to be adapted to varying fastener pin positions.

6. A method according to claim 5, characterised by adapting the attachment to varying length measurements of the fastener sleeves (11,14), by varying the thicknesses of flanges (50) provided on respective bushes (44-47).
